(19) United States
(12) Patent Application Publication
(10) Pub. No.: US 2014/0095371 A1
(43) Pub. Date: Apr. 3, 2014

(54) TIMING-BASED TRADE MATCHING

(71) Applicant: FastMatch, Inc., New York, NY (US)

(72) Inventors: Dmitri Galinov, New York, NY (US); Vladislav Rysin, Upper Grandview, NY (US)

(73) Assignee: FastMatch, Inc., New York, NY (US)

(21) Appl. No.: 13/972,015

(22) Filed: Aug. 21, 2013

Related U.S. Application Data
(60) Provisional application No. 61/708,898, filed on Oct. 2, 2012.

(51) Int. Cl. G06Q 40/04

(52) U.S. Cl. CPC G06Q 40/04
USPC 705/37

(57) ABSTRACT

Methods, systems and computer program products for timing-based trade matching are provided. A computer-implemented method may include receiving a quote for a financial instrument offered by a first party, the quote comprising a minimum period of time for the first party to process a matching order; receiving an order for the financial instrument from a second party, the order comprising a maximum period of time the second party is to wait for processing of an identified matching quote; determining whether the quote and the order are compatible by at least comparing the minimum period of time for the quote to the maximum period of time for the order; and adjusting a list of one or more orders that are compatible with the quote as a potential match.

### CROSS-REFERENCE TO RELATED APPLICATION

This application claims priority to U.S. Provisional Patent Application No. 61/708,898, filed Oct. 2, 2012, the disclosure of which is hereby incorporated by reference herein in its entirety.

### TECHNICAL FIELD

The field generally relates to exchange trading and more specifically to timing-based trade matching.

### BACKGROUND

An electronic trading platform is a computer system used to enable trading of financial products over a network. A “trade” generally describes an exchange of a financial instrument, such as stocks, bonds, commodities, currencies, derivatives, or any financial instrument of value, for cash. An electronic trading platform generally matches orders between liquidity seekers and liquidity providers.

An electronic trading platform may match an order with a quote based on a set of well-defined rules. When a match occurs, a quote provider may have a period of time to either accept or reject proposed terms of the deal. In the FX industry, this is known as a “last look.”

### SUMMARY

Embodiments generally relate to timing-based trade matching. In one embodiment, a processor receives a quote for a financial instrument offered by a first party, the quote comprising a minimum period of time for the first party to process a matching order. The processor also receives an order for the financial instrument from a second party, the order comprising a maximum period of time the second party is to wait for processing of an identified matching quote. The processor determines whether the quote and the order are compatible as a potential match by at least comparing the minimum period of time for the quote to the maximum period of time for the order. The processor also adjusts a list of one or more orders that are compatible with the quote as a potential match based on a result of comparing the minimum period of time for the quote with the maximum period of time for the order.

In another embodiment, a system includes a memory and a processor coupled to the memory to provide timing-based trade matching. The system receives a quote for a financial instrument offered by a first party, the quote comprising a minimum period of time for the first party to process a matching order. The system also receives an order for the financial instrument from a second party, the order comprising a maximum period of time the second party is to wait for processing of an identified matching quote. The system determines whether the quote and the order are compatible as a potential match by at least comparing the minimum period of time for the quote to the maximum period of time for the order. The system also adjusts a list of one or more orders that are compatible with the quote as a potential match based on a result of comparing the minimum period of time for the quote with the maximum period of time for the order.

In a further embodiment, a computer-readable medium has instructions that, when executed by a processor, cause the processor to perform operations. The instructions include computer-readable program code configured to cause the processor to receive a quote for a financial instrument offered by a first party, the quote comprising a minimum period of time for the first party to process a matching order. The computer-readable program code is also configured to cause the processor to receive an order for the financial instrument from a second party, the order comprising a maximum period of time the second party is to wait for processing of an identified matching quote. The computer-readable program code is also configured to cause the processor to determine whether the quote and the order are compatible as a potential match by at least comparing the minimum period of time for the quote to the maximum period of time for the order and to adjust a list of one or more orders that are compatible with the quote as a potential match based on the result of comparing the minimum period of time for the quote with the maximum period of time for the order.

Further embodiments, features, and advantages of the present invention, as well as the structure and operation of the various embodiments of the present invention are described in detail below with reference to accompanying drawings.

### BRIEF DESCRIPTION OF THE DRAWINGS

The present invention is illustrated by way of example, and not by way of limitation, and will become apparent upon consideration of the following detailed description, taken in conjunction with the accompanying drawings, in which like reference characters refer to like parts throughout, and in which:

FIG. 1 illustrates an example system architecture, in accordance with various embodiments of the present invention.

FIG. 2 illustrates a block diagram of a timing-based trade matching system architecture, in accordance with various embodiments of the present invention.

FIG. 3 is a flow diagram illustrating timing-based trade matching, in accordance with various embodiments of the present invention.

FIG. 4 is a block diagram of an exemplary computer system that may perform one or more of the operations described herein.

### DETAILED DESCRIPTION

Methods, systems and computer program products for timing-based trade matching are described. Rejected and unrealized deals are failed transactions that represent an opportunity cost loss to liquidity seekers, trading exchanges, and even liquidity providers that prefer order flow. Therefore, reducing rejection rates, increasing fill rates, and accelerating performance of trade execution benefits trading participants. Timing-based trade matching improves such metrics by ensuring the compatibility of timing-based trading constraints of liquidity seekers and liquidity providers.

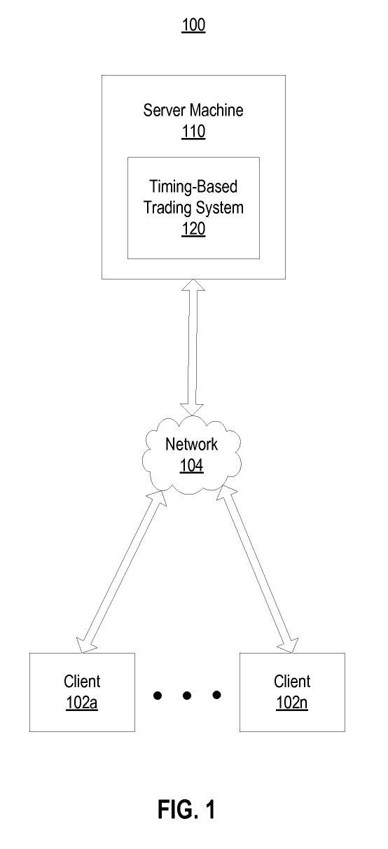

FIG. 1 illustrates an example system architecture, in accordance with various embodiments of the present invention. The system architecture 100 includes server machine 110, data store 140 and client machines 102A-102N connected to a network 104. Network 104 may be a public network (e.g., the Internet), a private network (e.g., a local area network (LAN) or wide area network (WAN)), or a combination thereof.

Client machines 102A-102N may be personal computers (PC), laptops, mobile phones, tablet computers, or any other computing device. The client machines 102A-102N may run an operating system (OS) that manages hardware and software of the client machines 102A-102N. An application or web browser (not shown) may run on the client machines 102A-102N (e.g., on the OS of the client machines), allowing the client machines 102A-102N to communicate with and access content provided by server machine 110.

Server machine 110 may be, for example, a rackmount server, a router computer, a personal computer, a portable digital assistant, a mobile phone, a laptop computer, a tablet computer, a netbook, a desktop computer, or any combination of the above. Server machine 110 may include a timing-based trading system 120 that runs on one or more physical and/or virtual machines.

In general, functions described in embodiments as being performed by server 110 or timing-based trading system 120 may also be performed on the client machines 102A-102N in other embodiments, if appropriate. In addition, functionality attributed to a particular component may be performed by different or multiple components operating together. Server 110 also may be accessed as a service provided to other systems or devices through appropriate application programming interfaces, application servers, websites, etc.

In an embodiment, server machine 110 is part of an electronic communication network (ECN) that facilitates trading of financial products outside of a stock exchange. In an example, server machine 110 is part of an ECN that automatically matches buy and sell orders at specified prices. For example, an ECN may allow parties (e.g., liquidity seekers and liquidity providers, such as client machines 102A-102N) to trade financial instruments directly, without the assistance of an exchange or market maker.

Timing-based trading system 120 may receive financial quotes and orders from various sources for one or more different types of financial instruments or securities. A financial instrument or financial instrument generally refers to a tradable asset of any kind, which may include, but is not limited to, debt securities, equity securities, derivative contracts, currency etc.

A financial quote generally refers to an “ask price” or a price at which a seller is willing to sell a financial instrument, while an order generally refers to a “bid price” work price at which a buyer is willing to acquire a financial instrument. Financial quotes and orders may include other information such as a quantity, a transaction type, a “time in force”, and timing-based constraints. A financial quote or an order each may have a quantity or number of units to transact.

A transaction type, such as a market order, a limit order, a pegged-to market/midpoint order may be specified. A “time in force” such as an “end of day”, “fill or kill” (FOK), or an “immediate or cancel” (IOC) designation may be specified. Timing-based constraints or parameters also may be specified for a specific quote, a specific order, a specific quote provider, a specific order provider, and/or by default (e.g., a system default).

In an example, a timing-based constraint for a quote or a quote provider may include a minimum period of time that the quote provider will use to process a matching order. For example, a financial quote may be provided with a parameter indicating how long the quote provider will need to process a matching order. In one example, the quote provider does not provide a minimum period of time that will be used to process a matching order, and timing-based trading system 120 uses a corresponding default value configured for the quote provider or a corresponding system default value, which may be used across one or more different quote providers.

In an example, a timing-based constraint for an order or an order provider may include a maximum period of time that the order provider is willing to wait to have a matching order processed by a quote provider (which may include “last look” delay associated with the quote provider). For example, an order may be provided with a parameter indicating a maximum period of time the order provider will wait for a matching order to be processed. In one example, the order provider does not provide a maximum period of time it will wait for processing of a matching order, and timing-based trading system 120 uses a corresponding default value configured for the order provider or a corresponding system default value, which may be used across one or more different order providers.

Timing-based trading system 120 may compare a minimum period of processing time for a quote to a maximum period of processing time that is acceptable from the order side to determine whether a quote and an order are compatible as a potential match. Timing-based trading system 120 also may adjust a generated list of orders that are compatible with the quote as a potential match. For example, timing-based trading system 120 may track compatible quotes and orders and provide such information to quote providers and order providers. For example, timing-based trading system 120 may send a list of compatible quotes/orders in a stream or display a list of compatible quotes/orders on a user interface. Timing-based trading system 120 may filter non-compatible quotes and orders based on timing constraints associated with quotes and orders to improve system efficiency, trader efficiency, and to ensure that executed trades involve compatible quotes and orders.

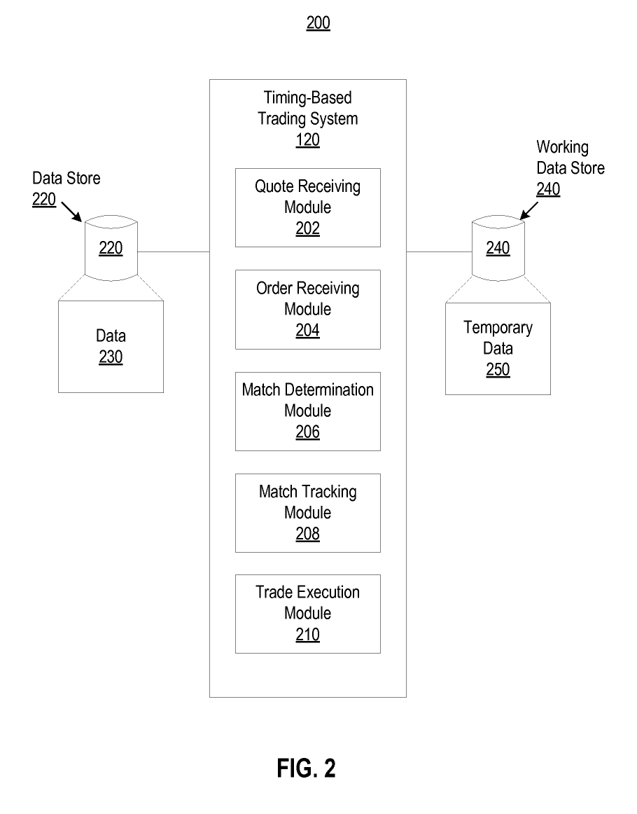

FIG. 2 illustrates a block diagram of a timing-based trade matching system architecture, in accordance with various embodiments of the present invention. The timing-based trading system 120 includes a quote receiving module 202, an order receiving module 204, a match determination module 206, a match tracking module 208, and a trade management module 210. In other embodiments, functionality associated with one or more of quote receiving module 202, order receiving module 204, match determination module 206, match tracking module 208, and trade management module 210 may be combined, divided and organized in various arrangements.

In an embodiment, timing-based trading system 120 is coupled to data store 220 and working data store 240. Data store 220 is persistent storage that is capable of storing various types of data. In some embodiments data store 220 might be a network-attached file server, while in other embodiments data store 220 might be some other type of persistent storage such as an object-oriented database, a relational database, and so forth. Data store 220 includes data 230, such as various information associated with quotes, orders, financial instruments, executed trades, etc.

Working data store 240 includes temporary data 250. In an example, timing-based trading system 120 utilizes working data store 240 as a temporary storage space. Working data store 240 may include temporary data 250 and results produced by timing-based trading system 120. For example, timing-based trading system 120 may use working data store 240 to store temporary data 250 needed to perform calculations and other functions. Working data store 240 may include, for example, any type or combination of volatile and non-volatile storage (e.g., disk, memory).

Quote receiving module 202 receives financial quotes from liquidity providers for financial instruments offered for sale by the liquidity providers. Order receiving module 204 receives orders from liquidity seekers that are looking to acquire financial instruments offered for sale. Match determination module 206 determines whether timing-based attributes of corresponding financial quotes and offers are compatible. Match tracking module 208 generates, maintains, and adjusts information associated with corresponding financial quotes and offers having compatible timing-based attributes. Trade management module 210 manages processing of trades involving financial quotes and offers that have been matched.

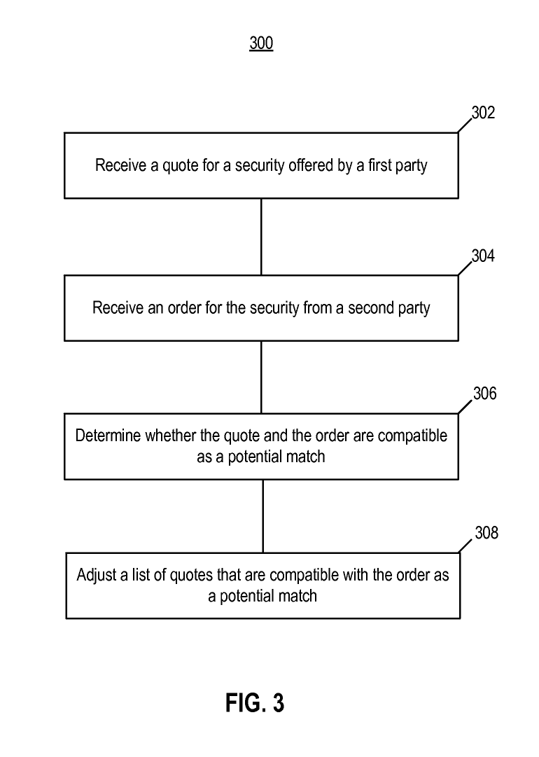

FIG. 3 is a flow diagram illustrating timing-based trade matching, in accordance with various embodiments of the present invention. The method 300 may be performed by processing logic that may comprise hardware (circuitry, dedicated logic, programmable logic, microcode, etc.), software (such as instructions run on a general purpose computer system, dedicated machine, or processing device), firmware, or a combination thereof. In one example, the method 300 is performed using timing-based trading system 120 of FIG. 1.

At stage 302, a quote is received for a financial instrument offered by a first party. In an embodiment, a financial quote comprising one or more timing-based attributes is received from a liquidity provider. In one example, a quote comprises a minimum period of time the liquidity provider will need to process a matching order. For example, a minimum fill timeout may represent an amount of time that the liquidity provider requires to process a matching order notification that it receives. In an example, the minimum fill timeout may represent some or all of the time that a liquidity provider uses to perform a “last look” (e.g., in milliseconds).

In an embodiment, an exchange, an ECN provider, or a party managing a transaction between a liquidity seeker and a liquidity provider may assign a minimum fill timeout that has been configured for a liquidity provider to one or more quotes that have been received from the liquidity provider. For example, the minimum fill timeout may be assigned to a quote by default when no minimum fill timeout has been provided by a corresponding liquidity provider. The minimum fill timeout associated with a specific liquidity provider account may be, for example, a predefined value specified by the liquidity provider, may be an observed value provided by an exchange or ECN, or may be an exchange or ECN system default that can be applied to or on behalf of one or more different liquidity providers. In one embodiment, a minimum fill timeout value is provided in a field in an electronic message formatted according to a version of a financial information exchange (FIX) protocol. In one example, stage 302 is performed by quote receiving module 202.

At stage 304, an order for the financial instrument is received from a second party. In an embodiment, an order for a quantity of a specific financial instrument is received from a liquidity seeker. In one example, the order comprises a maximum period of time that the liquidity seeker is willing to wait for a liquidity provider of a matching quote to process the order. For example, the liquidity seeker may specify a maximum delay in milliseconds that indicates the amount of time that the liquidity seeker is willing to wait for processing of a matching quote to complete. In an example the maximum delay may represent a period of time that the liquidity seeker is willing to wait for an equity provider to perform its “last look.”

In an embodiment, an exchange, ECN provider, or another party managing transactions between liquidity seekers and liquidity providers may assign a maximum delay timing-based attribute value to one or more orders received by a liquidity seeker. For example, a maximum delay value may be assigned to an order by default when no maximum delay has been provided by a corresponding liquidity seeker. The maximum delay value that is assigned to an order may be, for example, a predefined default value specified by the liquidity seeker, or may be a system default (e.g., 100 milliseconds) that can be applied to or on behalf of one or more different liquidity seekers. In one embodiment, a maximum delay value is provided in a field in an electronic message formatted according to a version of a financial information exchange (FIX) protocol.

In an embodiment, the liquidity seeker may selectively control the maximum delay or time that an order will be allowed to wait for last look confirmation of a matching quote from a quote provider. For example, a liquidity seeker may provide a maximum delay attribute value when requesting creation of a new order. The liquidity seeker also may set or update the maximum delay attribute value for a pending order. In an example, stage 304 is performed by order receiving module 204.

At stage 306, a determination is made as to whether the quote and the order are compatible as a potential match. In an embodiment, a timing-based trade matching system 120 associated with an exchange or ECN performs matching of quotes and orders, which may include matching quotes and orders based on time constraints. In one example, timing-based constraints may be used, among other criteria, when matching orders and quotes. For example, an order may be isolated from quotes having minimum fill timeout exceeding the maximum delay of the order. In an example, quotes and orders may be received by an electronic communications network (ECN) providing foreign exchange trading services.

The maximum delay attribute value associated with an order may be compared to the minimum fill timeout attribute value of a quote to determine whether the order and the quote are compatible as a potential match, at least according to such timing based constraints. When the minimum period of time for the quote exceeds the maximum delay for the order then it may be determined that the quote and the order are incompatible as a potential match. On the other hand, when the minimum period of time for the quote does not exceed the maximum delay for the order, then the order and the corresponding quote may be identified as a potential match. In an example, stage 306 is performed by match determination module 206.

At stage 308 an adjustment is made to a list of quotes that are compatible with the order as a potential match. In an embodiment, a liquidity seeker may receive or be provided with quotes from one or more liquidity providers. Each of the respective quotes may have its own set of one or more timing-based constraints, which may include a minimum period of time to process a quote (i.e., a minimum timeout value). In an example, quotes and corresponding timing-based constraint information may be transmitted to liquidity seekers via a market data feed of an exchange or ECN. A liquidity seeker also may request and receive a list of quotes and corresponding timing-based constraint information, for example, via a web, desktop, or mobile application for display on a user interface. A liquidity seeker may selectively control which quotes may be matched to an order by setting or updating the maximum delay attribute value of the order. In addition, a user request, query, or feed may be filtered based on timing based constraints, and a corresponding list of compatible quotes may be generated, adjusted and matched against an order based on timing-based constraints.

In an embodiment, one or more quotes are matched to an order when the minimum period of time to process each of the respective quotes (i.e., each minimum timeout value) does not exceed the maximum delay for the order. In one example, a single quote may be matched to a single order to fill the entire order. In another example, multiple (different) quotes may be matched to a single order to fill the entire order (where each matching quote partially fills the order). In general, a quote may be matched to one or more different orders, and an order may be matched to one or more different quotes at any point in time.

In an embodiment, an available quantity of a financial instrument (e.g., a security) associated with a quote is reserved when the quote is matched to an order. For example, the quote may be reserved and may not participate in further matching once an order is matched to the quote. Further, an open quantity for the quote also may be decremented by a size of the matching order. In one example, a quote that already has been matched to an order may not be canceled until either a timeout expires (e.g., a minimum timeout value or a maximum delay timing-based constraint is exceeded for a pending order), or a trade for the match is executed and confirmed by an execution report.

In an embodiment, a reserved quantity of a financial instrument is released when an order is canceled (e.g., by a liquidity provider when performing a “last look” or when a maximum delay timing-based constraint is exceeded). In one example, a previously reserved quantity of a financial instrument is released and again becomes available for matching against other orders. In an example, an open quantity of an order adjusted in view of an order cancellation/timeout by incrementing an open quantity for the order by a quantity corresponding to the canceled matching quote.

In one embodiment, an originator or owner of a quote receives an order (e.g., IOC, FOK, etc.) that has been matched to the quote from an exchange or ECN. In one example, the order comprises information, such as a price, a quantity, a currency pair, and a timeout value during which an available quantity of a financial instrument offered by the quote will be reserved. In an example, a liquidity provider may partially fill and/or partially cancel an order when the order is IOC. In another example, a liquidity provider must fill a FOK order entirely or the FOK order will be canceled.

In one embodiment, an entire quote may be canceled when at least one order matched to the quote is canceled, irrespective of the reason. In an example, an entire open/available quantity of a financial instrument may be canceled immediately when an attempt is made to cancel a quote. In one example, any portion of a quote previously matched to an order may be allowed to complete its normal cycle when a quote is canceled.

In an embodiment, an attempt is made to cancel an order when processing of matching quotes is pending completion. In one example, any unmatched quantity of the order is canceled, the order is marked for cancellation (meaning, the order will no longer be included in the matching process), previously matched quantities may be allowed to complete, and additional quantities of the order may be canceled, if necessary. In an example, stage 308 is performed by match tracking module 208 and trade management module 210.

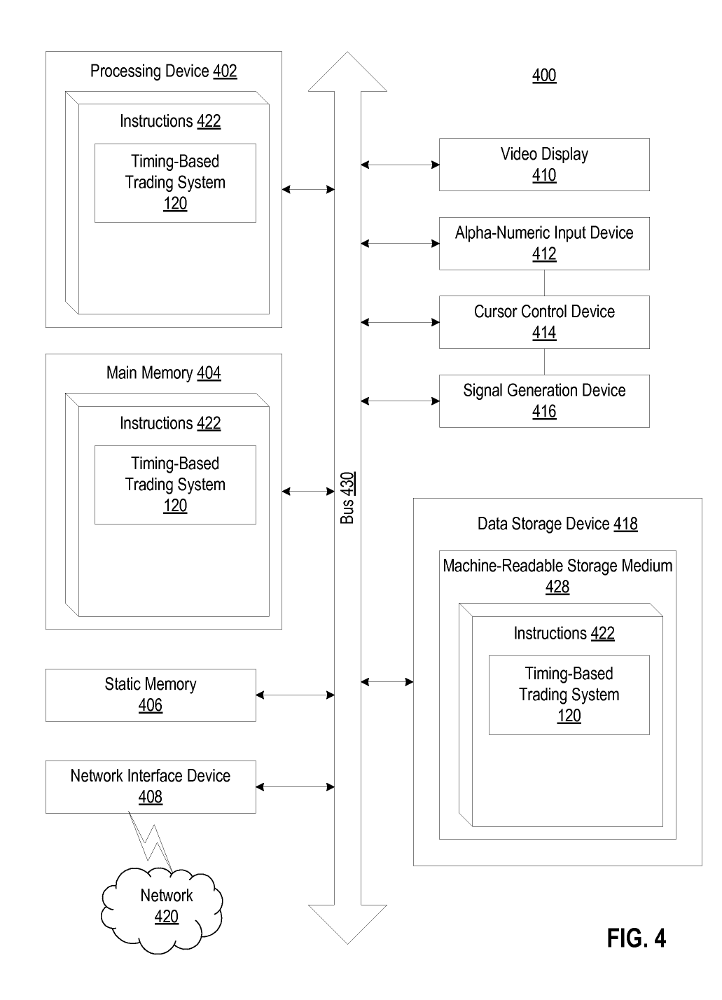

FIG. 4 illustrates a diagram of a machine in the exemplary form of a computer system 400 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 400 includes a processing device (processor) 402, a main memory 404 (e.g., read-only memory (ROM), flash memory, dynamic random access memory (DRAM) such as synchronous DRAM (SDRAM), double data rate (DDR SDRAM), or DRAM (RDRAM), etc.), a static memory 406 (e.g., flash memory, static random access memory (SRAM), etc.), and a data storage device 418, which communicate with each other via a bus 430.

Processor 402 represents one or more general-purpose processing devices such as a microprocessor, central processing unit, or the like. More particularly, the processor 402 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 402 may also be one or more special-purpose processing devices such as an application specific integrated circuit (ASIC), a field programmable gate array (FPGA), a digital signal processor (DSP), network processor, or the like. The processor 402 is configured to execute instructions 422 for performing the operations and steps discussed herein.

The computer system 400 may further include a network interface device 408. The computer system 400 also may include a video display unit 410 (e.g., a liquid crystal display (LCD) or a cathode ray tube (CRT)), an alphanumeric input device 412 (e.g., a keyboard), a cursor control device 414 (e.g., a mouse), and a signal generation device 416 (e.g., a speaker).

The data storage device 418 may include a computer-readable storage medium 428 on which is stored one or more sets of instructions 422 (e.g., software) embodying any one or more of the methodologies or functions described herein. The instructions 422 may also reside, completely or at least partially, within the main memory 404 and/or within the processor 402 during execution thereof by the computer system 400, the main memory 404 and the processor 402 also constituting computer-readable storage media. The instructions 422 further may be transmitted or received over a network 420 via the network interface device 408.

In one embodiment, the instructions 422 include instructions for a timing-based trade matching system (e.g., timing-based trade matching system 120 of FIG. 1) and/or a software library containing methods that call a timing-based trade matching module. While the computer-readable storage medium 328 (machine-readable storage medium) is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present invention may be practiced without these specific details. In some instances, well-known structures and devices are shown in block diagram form, rather than in detail, to avoid obscuring the present invention.

Some portions of the detailed description have been presented in terms of algorithms and symbolic representations of operations on data bits within a computer memory. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “computing”, “comparing”, “determining”, “adjusting”, “applying”, “creating”, “ranking,” “classifying,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Certain embodiments of the present invention also relate to an apparatus for performing the operations herein. This apparatus may be constructed for the intended purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Many other embodiments will be apparent to those of skill in the art upon reading and understanding the above description. The scope of the invention should therefore be determined with reference to the appended claims, along with the full scope of equivalents to which such claims are entitled.

What is claimed is:

1. A computer-implemented method, comprising:
receiving, by a processor, a quote for a financial instrument offered by a first party, the quote comprising a minimum period of time for the first party to process a matching order;
receiving, by the processor, an order for the financial instrument from a second party, the order comprising a maximum period of time the second party is to wait for processing of an identified matching quote;
determining, by the processor, whether the quote and the order are compatible as a potential match by at least comparing the minimum period of time for the quote to the maximum period of time for the order; and
adjusting, by the processor, a list of one or more orders that are compatible with the quote as a potential match.

2. The method of claim 1, further comprising:
determining that the quote and the order are incompatible as a potential match when the minimum period of time for the quote exceeds the maximum period of time for the order.

3. The method of claim 1, further comprising:
identifying the order as a potential match for the quote when the minimum period of time for the quote does not exceed the maximum period of time for the order.

4. The method of claim 1, further comprising:
matching the quote with the order when minimum period of time for the quote does not exceed the maximum period of time for the order.

5. The method of claim 4, further comprising:
reserving an available quantity of the financial instrument associated with the quote when processing the order.

6. The method of claim 4, further comprising:
releasing the reserved quantity of the financial instrument associated with the quote when the maximum period of time is exceeded when processing the order.

7. The method of claim 1, wherein the minimum period of time is a default period of time used when a minimum period of time value is not provided with the quote by the first party.

8. The method of claim 1, wherein the maximum period of time is a default period of time used when a maximum period of time value is not provided with the order by the second party.

9. The method of claim 1, wherein at least one of the minimum period of time and the maximum period of time is a system default parameter.

10. The method of claim 1, wherein the minimum period of time for the quote is provided as a field in an electronic message formatted according to a version of a financial information exchange (FIX) protocol.

11. The method of claim 1, wherein the maximum period of time for the order is provided as a field in an electronic message formatted according to a version of a financial information exchange (FIX) protocol.

12. The method of claim 1, wherein the quote and the order are received by an electronic communication network providing foreign exchange trading services.

13. A system, comprising:
a memory; and
a processor coupled with the memory to:
receive a quote for a financial instrument offered by a first party, the quote comprising a minimum period of time for the first party to process a matching order;
receive an order for the financial instrument from a second party, the order comprising a maximum period of time the second party is to wait for processing of an identified matching quote;
determine whether the quote and the order are compatible as a potential match by at least comparing the minimum period of time for the quote to the maximum period of time for the order; and
adjust a list of one or more orders that are compatible with the quote as a potential match.

14. The system of claim 13, wherein the processor further is to:
determine that the quote and the order are incompatible as a potential match when the minimum period of time for the quote exceeds the maximum period of time for the order.

15. The system of claim 13, wherein the processor further is to:
identify the order as a potential match for the quote when the minimum period of time for the quote does not exceed the maximum period of time for the order.

16. The system of claim 13, wherein the processor further is to:
match the quote with the order when minimum period of time for the quote does not exceed the maximum period of time for the order.

17. A computer readable medium having instructions recorded thereon that, when executed by a processor, cause the processor to perform operations comprising:
receiving, by the processor, a quote for a financial instrument offered by a first party, the quote comprising a minimum period of time for the first party to process a matching order;
receiving, by the processor, an order for the financial instrument from a second party, the order comprising a maximum period of time the second party is to wait for processing of an identified matching quote;
determining, by the processor, whether the quote and the order are compatible as a potential match by at least comparing the minimum period of time for the quote to the maximum period of time for the order; and
adjusting, by the processor, a list of one or more orders that are compatible with the quote as a potential match.

18. The computer readable medium of claim 17, the operations further comprising:
determining that the quote and the order are incompatible as a potential match when the minimum period of time for the quote exceeds the maximum period of time for the order.

19. The computer readable medium of claim 17, the operations further comprising:
identifying the order as a potential match for the quote when the minimum period of time for the quote does not exceed the maximum period of time for the order.

20. The computer readable medium of claim 17, the operations further comprising:
matching the quote with the order when minimum period of time for the quote does not exceed the maximum period of time for the order.
